(19) United States
(12) Patent Application Publication
(10) Pub. No.: US 2001/0034675 A1
(43) Pub. Date: Oct. 25, 2001

(54) Legal expense tracking and approval methods and systems

(76) Inventors: Eugene J. Belford, Cheshire, CT (US); Martha C. Poulter, Sandy Hook, CT (US); Susan L. Poland, Greenwich, CT (US); Denise A. Vaios, Old Greenwich, CT (US); Patricia Glynn, Wilton, CT (US); Robert Obolewicz, Westport, CT (US); Julie A. Giglio, Stamford, CT (US)

Correspondence Address: JOHN S. BEULICK, C/O ARMSTRONG TEASDALE, LLP, ONE METROPOLITAN SQUARE, SUITE 2600, ST LOUIS, MO, 63102-2740, US

(21) Appl. No.: 09/681,492

(22) Filed: Apr. 17, 2001

Related U.S. Application Data
(60) Provisional application No. 60/198,885, filed on Apr. 19, 2000.

(51) Int. Cl. G06F 17/60

(52) U.S. Cl. 705/30; 705/39; 705/40

(57) ABSTRACT

Methods and systems for tracking and approving legal expenses using a legal expense tracking system are disclosed. The method includes selecting a legal matter identifier for the legal work, engaging an outside counsel regarding planned legal work through a prompt, prompting the outside counsel to input data relating to expenses received from a legal services invoice, prompting a user for an approval of submitted legal invoices, and generating legal expense reports.

### CROSS REFERENCE TO RELATED APPLICATIONS

This application claims the benefit of U.S. Provisional Application No. 60/198,885, filed Apr. 19, 2000.

### BACKGROUND OF INVENTION

This invention relates generally to expense tracking and more specifically to computerized methods and systems for tracking and approving legal expenses related to loan transactions.

Legal fees incurred due to loan transactions typically are charged by lenders to borrowers as part of the cost of the loan. Such legal fees include, for example, the expenses associated with obtaining a legal opinion from a law firm with respect to assets to be utilized as collateral in securing the loan. One lender may utilize multiple law firms, and any one of such firms may provide multiple opinions for many different loans.

There is no known consistent and reliable process for tracking legal expenses related to loan transactions. As a consequence, lenders find it difficult to determine if legal expenses are higher than they should have been or have been on past transactions. Without this information, lenders have difficulty in managing the costs associated with securing opinions and other work performed by law firms.

### SUMMARY OF INVENTION

Methods and systems by which a lender can monitor, evaluate, and possibly reduce legal bills are described herein. In one embodiment, a method for tracking legal expense begins with generation of a legal matter identifier and the selection of outside counsel. A budget worksheet is then used to develop a budget for the particular project with the law firm. Over the course of the project, actual costs of services provided by the law firm also are captured on the worksheet. Approval for payment of legal invoices in a consistent manner in reduced time is accomplished using a streamlined invoice. Legal expense reports also are generated which management can use to identify opportunities to address legal expenses.

In another aspect, a computer is programmed to prompt an outside counsel regarding planned legal work, the legal work identified by a legal matter identifier. Further, the computer prompts the outside counsel to input data relating to expense and to prompt a user for an approval of the expense. After approval, the computer is configured to generate legal expense reports.

In other aspects a database includes data corresponding to the legal matter identifier, the contacting of outside counsel, legal expenses and approval of the legal expenses and a computer-readable medium includes records corresponding to legal matter identifiers, records corresponding to outside counsel, records of submitted legal expenses and rules for approval of submitted legal expenses and transmission to an accounting system.

In yet another aspect, a networked system for legal expenses tracking and approval is provided which includes a computer configured as a server which generates legal expense reports using a legal expense database which has stored data corresponding to a legal matter identifier, data corresponding to contacting of outside counsel, data corresponding to legal expenses and data corresponding to approval of the legal expenses. At least one other computer coupled to the server forms a network. The system includes an interface allowing the other computers and the server to communicate, allowing upload and download of data relating to legal invoices, legal expense data, such as, legal expense reports.

In a further aspect, an apparatus is provided which includes means for prompting an outside counsel regarding planned legal work, means for prompting the outside counsel to input data relating to at least one expense, means for prompting a user for an approval of the expense, and means for generating at least one legal expense report.

### BRIEF DESCRIPTION OF DRAWINGS

FIG. 1 is a system block diagram.

FIG. 2 is a detailed block diagram of a network based system.

FIG. 3 is a flow chart setting forth process steps for engaging a law firm.

FIG. 4 is an exemplary embodiment of a first portion of a budget worksheet.

FIG. 5 is a second portion of the budget worksheet shown in FIG. 4.

FIG. 6 is a user interface screen for a core tracking system.

FIG. 7 is a user interface screen for a participation tracking system.

FIG. 8 is a flow chart setting forth process steps for legal invoice approval.

FIG. 9 is one embodiment of a legal invoice approval form.

FIG. 10 is an example of a database report illustrating a summary of legal invoices by geographic region.

FIG. 11 is an example of a database report illustrating a summary of legal invoices by work classification.

### DETAILED DESCRIPTION

The present invention, in one aspect, is a computer-based method for tracking and approving legal expenses. The computerized method increases quality in the tracking of legal expenses and reduces the manual effort required to manage legal expenses and therefore supports decision making and continuous improvement.

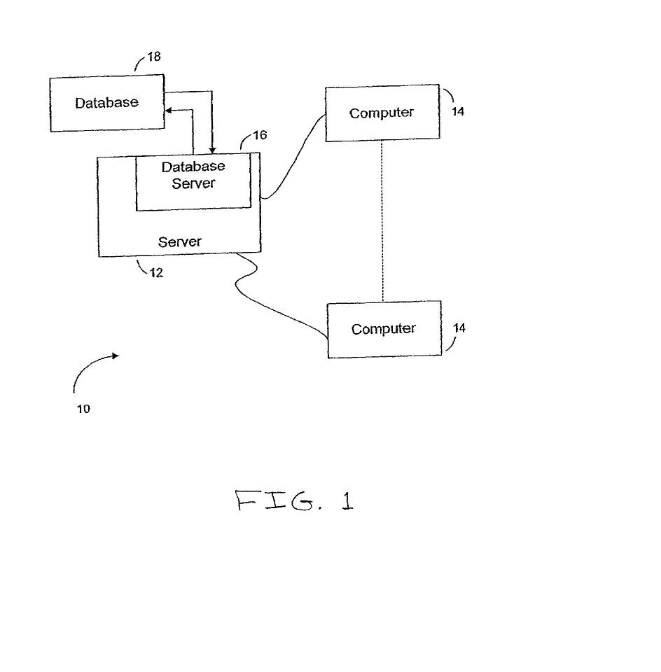

More specifically, FIG. 1 is a block diagram of a system 10 that includes a server sub-system 12, sometimes referred to herein as server 12, and a plurality of customer devices 14 connected to server 12. Computerized modeling and grouping tools, as described below in more detail, are stored in server 12 and can be accessed by a requester at any one of computers 14. In one embodiment, devices 14 are computers including a web browser, and server 12 is accessible to devices 14 via a network such as an intranet or a wide area network such as the Internet. In an alternative embodiment, devices 14 are servers for a network of customer devices. Computer 14 could be any client system capable of interconnecting to the Internet including a web based digital assistant, a web-based phone or other web-based connectable equipment.

Devices 14 are interconnected to the network, such as a local area network (LAN) or a wide area network (WAN), through many interfaces including dial-in-connections, cable modems and high-speed lines. Alternatively, devices 14 are any device capable of interconnecting to a network including a web-based phone or other web-based connectable equipment. Server 12 includes a database server 16 connected to a centralized database 18. In one embodiment, centralized database 18 is stored on database server 16 and is accessed by potential customers at one of customer devices 14 by logging onto server sub-system 12 through one of customer devices 14. In an alternative embodiment centralized database 18 is stored remotely from server 12.

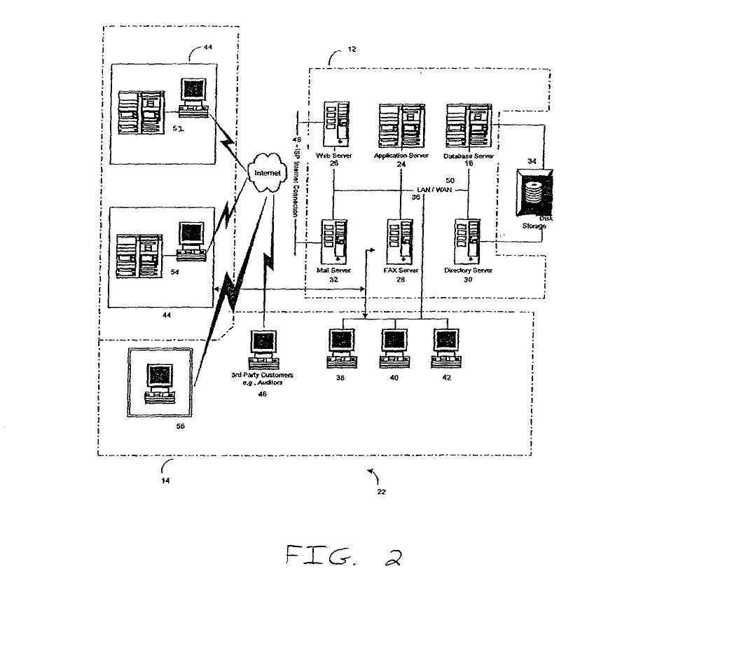

FIG. 2 is a block diagram of a network based system 22. System 22 includes server sub-system 12 and customer devices 14. Server sub-system 12 includes database server 16, an application server 24, a web server 26, a fax server 28, a directory server 30, and a mail server 32. A disk storage unit 34 incorporating a computer-readable medium is coupled to database server 16 and directory server 30. Servers 16, 24, 26, 28, 30, and 32 are coupled in a local area network (LAN) 36. In addition, a system administrator work station 38, a work station 40, and a supervisor work station 42 are coupled to LAN 36. Alternatively, work stations 38, 40, and 42 are coupled to LAN 36 via an Internet link or are connected through an intranet.

Each work station 38, 40, and 42 is a personal computer including a web browser. Although the functions performed at the work stations typically are illustrated as being performed at respective work stations 38, 40, and 42, such functions can be performed at one of many personal computers coupled to LAN 36. Work stations 38, 40, and 42 are illustrated as being associated with separate functions only to facilitate an understanding of the different types of functions that can be performed by individuals having access to LAN 36.

Server sub-system 12 is configured to be communicatively coupled to various individuals or employees 44 and to third parties, e.g., customer, 46 via an ISP Internet connection 48. The communication in the exemplary embodiment is illustrated as being performed via the Internet, however, any other wide area network (WAN) type communication can be utilized in other embodiments, i.e., the systems and processes are not limited to being practiced via the Internet. In addition, and rather than a WAN 50, local area network 36 could be used in place of WAN 50.

In the exemplary embodiment, any employee 44 or customer 46 having a work station 52 can access server sub-system 12. One of customer devices 14 includes a work station 54 located at a remote location. Work stations 52 and 54 are personal computers including a web browser. Also, work stations 52 and 54 are configured to communicate with server sub-system 12. Furthermore, mail server 32 facilitates communications, via E-mail, with employees 44 and customers 46 located outside the business entity and any of the remotely located customer systems, including a customer system 56. Mail server 32 is configured to provide E-mail communications through other work stations 38, 40, and 42 as well.

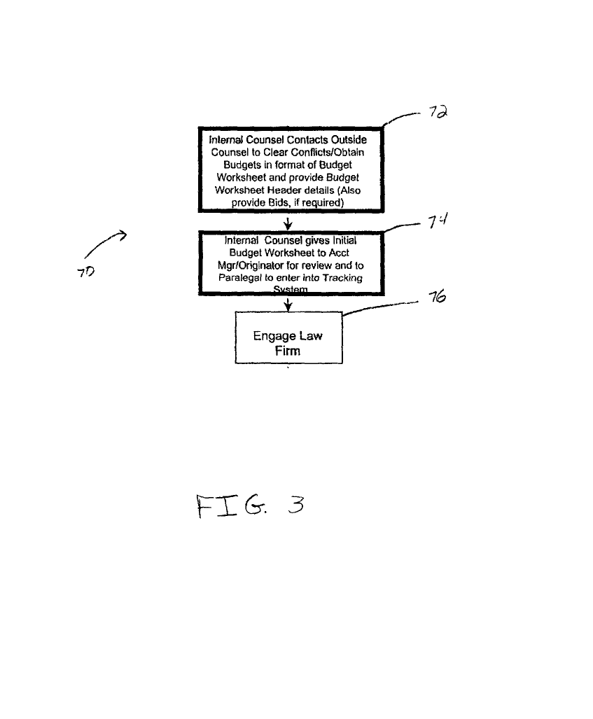

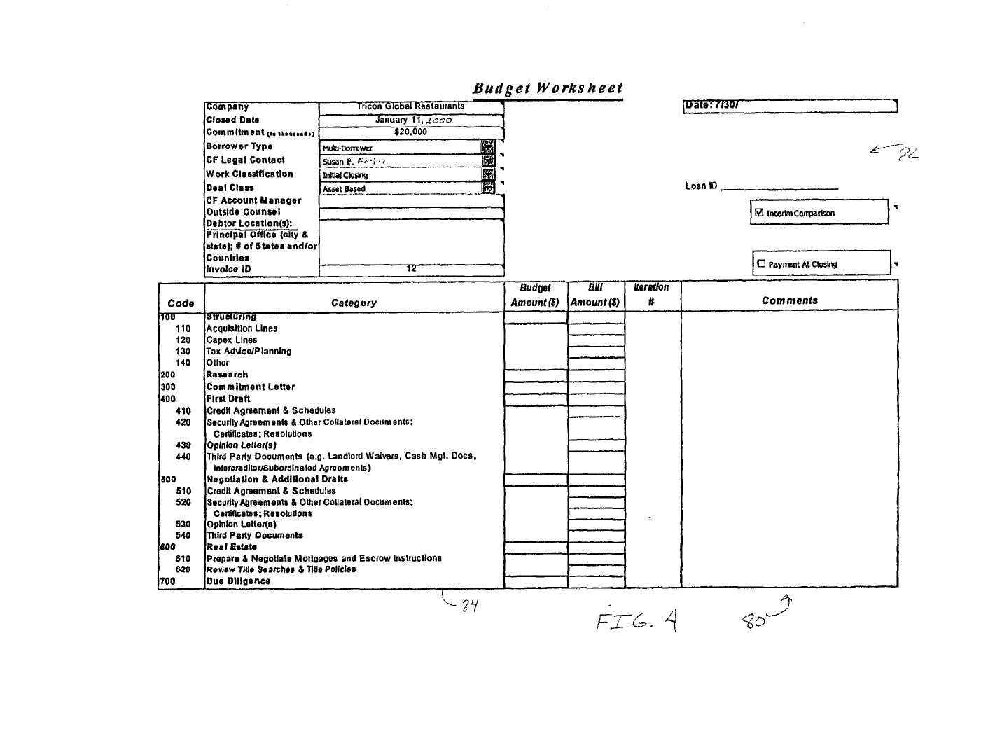

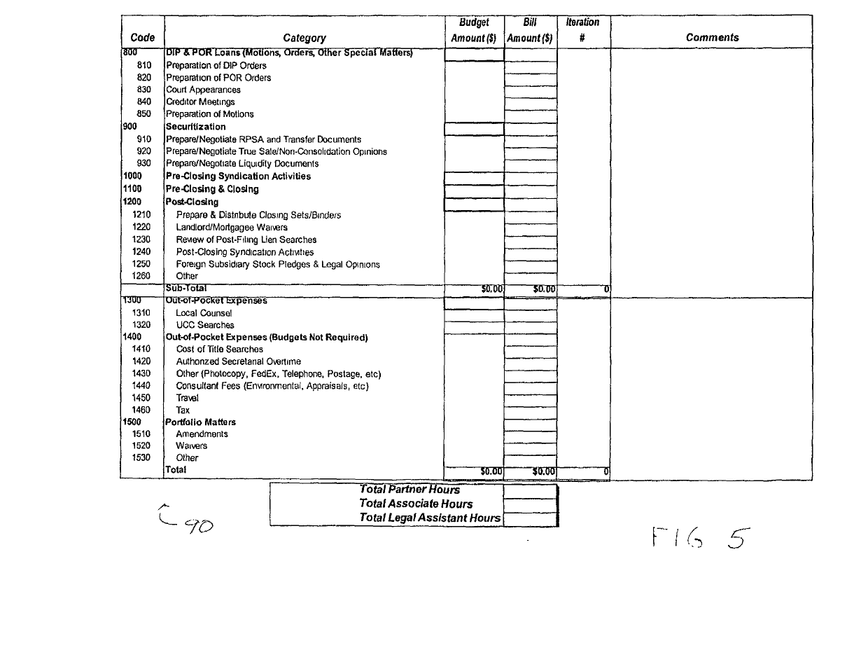

Referring to FIG. 3, a flow chart 70 diagramming exemplary steps executed in an engagement of a law firm is shown. More specifically, a company contacts 72 outside counsel to clear conflicts of interest that might exist from that firm's prospective representation of the company for this transaction. Internal counsel also obtains budgets from outside counsel in the format of a budget worksheet (described in FIGS. 4 and 5). Internal counsel also provides outside counsel header details, including a legal matter identifier, for the budget worksheet. Internal counsel then gives 74 an initial budget worksheet to an account manager or an originator for review. Initial budget worksheet data is entered into tracking system 10 (shown in FIG. 1). The outside law firm is subsequently engaged 76.

FIG. 4 is one embodiment of a budget worksheet 80 used for data entry and to capture budgeted and actual legal expenses. Data entered is uploaded to server 12 for storage in database 16 (both shown in FIGS. 1 and 2). Budget worksheet 80 includes a budget worksheet first portion 82 containing descriptions for a plurality of data entry fields, the data entry to be performed by outside counsel. Fields include name of the principal borrower and, if applicable, a project name. An estimated Closed Date field is configured for closure date input, unless the project is a company portfolio matter. A total size of the company loan commitment field including loan commitment and other fundings are entered. A borrower type field and a company's internal legal contact field for the outside counsel are also shown. A work classification field specifies whether the budget is for a deal that has not closed yet or whether it is for work to be done for a loan already in the company's portfolio. Likewise, type of loan or a deal classification field, for instance, asset based, is also available. In the embodiment shown in FIG. 4 borrower type, legal contact, work classification, and deal classification field are configured as pull down menus and the data to be entered is selected from the pull-down menu.

In addition, an Account Manager field is available for entry of the name of the principal company business contact for the deal. An outside counsel field for entry of the name of the outside counsel assigned to the project is also entered. There is also an address field for the address (city and state) of the principal office to be filled in by outside counsel if known when the budget is prepared. An Invoice ID number field is not entered by outside counsel at the budget stage. An administrative assistant or paralegal within the company will provide outside counsel with invoice information when the bill is rendered.

In one embodiment, budget worksheet first portion 82 is completed by outside counsel when contacted by the company's internal counsel. Outside counsel enters all known information into first portion 82 of the worksheet as is known when outside counsel prepares the budget.

Also included in budget worksheet 80 is a date of completion data entry field for the date of completion of the budget worksheet. A field for a Loan ID number also is included. Loan ID number is entered by company personnel. Further, an Interim Comparison field and a Payment at Closing field, which in the embodiment shown, consist of two boxes that can be checked. Interim Comparison field should be checked by outside counsel if a bill-to-budget comparison is done prior to closing. Alternatively, Payment at Closing field should be checked if the outside counsel's bill is rendered at closing.

A spreadsheet 84 for the inputting of budget information is included in budget worksheet 80. Included in spreadsheet 84 is a code number column for entry of different legal tasks. A category column for includes descriptions of different legal work items. Categories such as Structuring, Research, First Draft, Real Estate and Due Diligence is a non-exhaustive list of categories available. Certain categories also include sub-categories. As an example, the First Draft category includes subcategories such as Opinion Letter(s) and Third Party Documents among others.

A budget amount column, in spreadsheet 84 includes data entry fields for each legal action. Outside counsel enters data for as many of the legal actions as will apply to the deal. When outside counsel prepares to render the bill, outside counsel enters an amount in a Bill Amount column, reflecting the amount that was actually billed for each category and sub-category work item. Additionally outside counsel enters a number into Iteration Number column which indicates the number of drafts of the documents listed in Category column. Typically there are three drafts. The first draft is an internal draft for company purposes only. The two remaining drafts are for the entire working group. A Comments column is provided where outside counsel addresses reasons for differences between budget and actual amounts for as many categories as possible. Also, outside counsel will note any changes in facts from the time when the budget was prepared such as changes in deal structure. Also, if a portion of the final bill is an estimate of fees until closing, then outside counsel will note that fact and list the amount.

FIG. 5 is a continuation 90 of budget worksheet 80 shown in FIG. 4. Included in continuation 90 of the budget worksheet are a sub-total line configured for the summation of the amounts in budget amount column and Bill Amount column for legal items performed from the beginning to post-closing of the transaction. Also included in the spreadsheet are data entry fields for legal related expenses not included in subtotal line. Subcategories for local counsel and UCC Searches have data entry fields in budget amount column as well as in bill amount column which enable the company to quickly determine the amount billed for each legal work item and how the amount billed compares with the amount budgeted. A total line totals all monies budgeted and billed. Finally, a box in which the total number of hours billed by the outside law firm's partners, associates and legal assistants can be delineated.

Once all of the data has been entered into budget worksheet 80, outside counsel uploads the entered data to system 22 to be stored in database 16. Alternatively, outside counsel sends the completed budget worksheet and a copy of the outside counsel's legal bill to Company's internal counsel and her or his administrative assistant or paralegal via e-mail, when possible, or by fax.

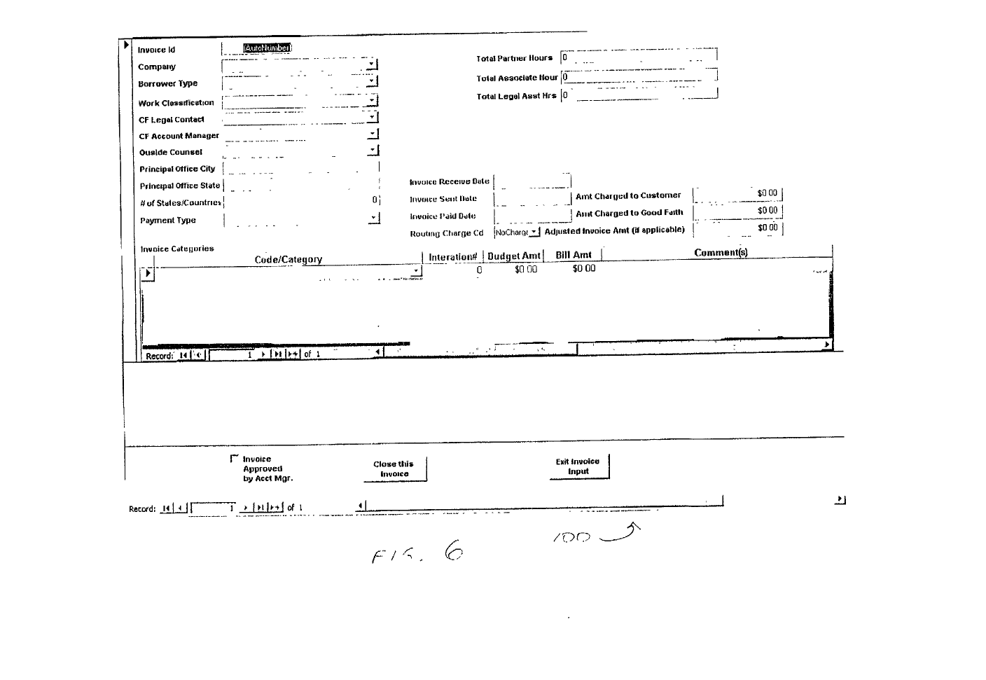

FIG. 6 is an embodiment of a Core Tracking System Input Screen 100 for entry of legal invoice information into database 16 (shown in FIGS. 1 and 2). Data is entered into data entry fields by a user or is retrieved from database 16 for the data entry fields that are common with budget worksheet 80. Data entry fields included in screen 100 which are common with those in budget worksheet 80 (shown in FIGS. 4 and 5) are an Invoice ID, a principal borrower and a project name, a borrower type, work classification, a company legal contact, a company Account Manager, outside counsel, a city and state of the principal office including a number of states and/or countries that the principal conducts business. Also included on screen 100 are total partner hours, total associate hours and total legal assistant hours billed. In the embodiment shown in FIG. 6, several of the data entry fields are configured as pull-down menus.

As further shown in FIG. 6, data entry fields exist for a payment type, a date the invoice from outside counsel was received, a date such invoice was sent, a date the invoice was paid by the company. Also included are data entry fields which show an amount charged to a customer where the company can enter the amount of the legal invoice that is charged to the customer or borrower in the transaction, an amount charged to good faith the amount of the legal invoice that the company is absorbing or charging off to good faith, and an adjusted invoice amount. A routing charge code field, which is configured as a pull-down menu in the embodiment shown in FIG. 6, is included.

A record input area where information from the spreadsheet 84 (shown in FIG. 4) of the budget worksheet can be viewed, along with that items associated costs. Also included are data entry fields where a paralegal can check a box to indicate whether this invoice has been approved by the Account Manager, close the invoice, or exit invoice input.

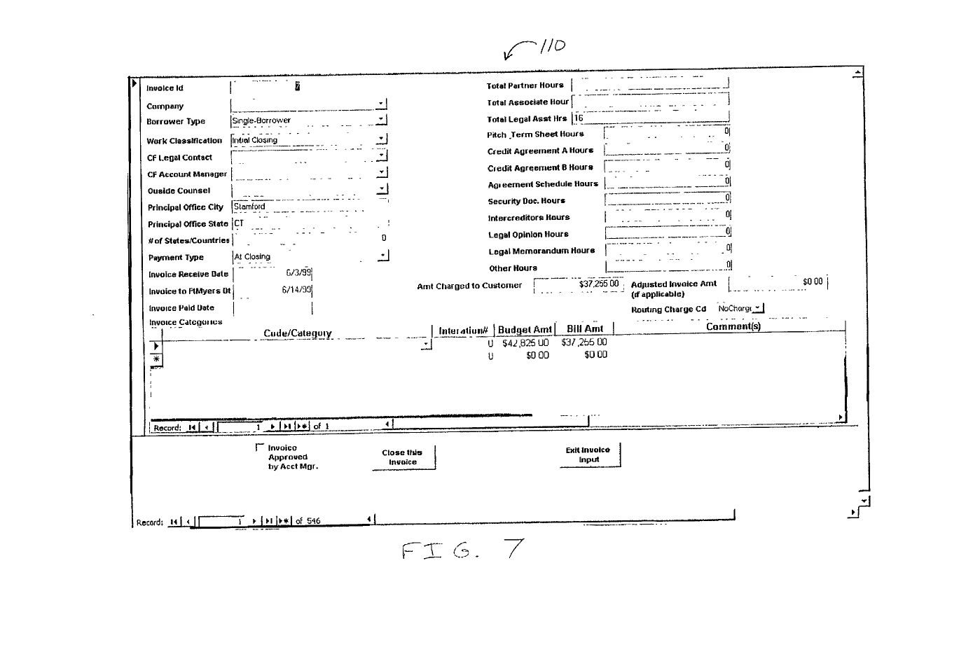

A Participation Tracking System Input Screen 110 is shown in FIG. 7. Screen 110 includes many of the data entry fields described in the Core Tracking System Input Screen 100 (shown in FIG. 6). In addition, screen 110 includes data entry fields delineating hours spent on different types of legal work, such as hours spent on a pitch term sheet, hours spent on preparing credit agreements, hours spent on an agreement schedule, security document hours, intercreditors hours, hours spent on the legal opinion or legal memorandum and other hours.

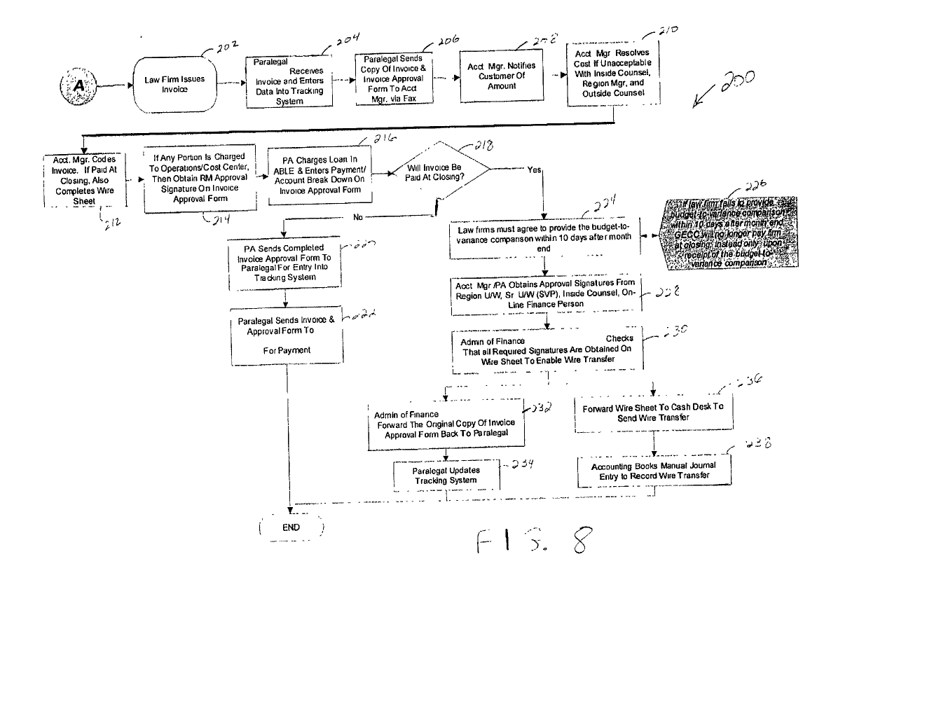

FIG. 8 is a flowchart 200 detailing a Legal Invoice Process Map. The process begins when a law firm invoice is issued 202. Then the invoice is received 204 and the data from the invoice is entered into the tracking system. Receipt 204 is also considered a control point by which the company can take action. A copy of the invoice is then sent 206 along with an Invoice Approval form to the Account Manager, in one embodiment, via fax. The Account Manager then notifies 208 the customer or borrower of the amount of the invoice. The Account Manager resolves 210 the cost of the invoice if the amount is unacceptable with inside counsel, region manager and outside counsel. The Account Manager then codes 212 the invoice. If the invoice is paid at Closing, then the Account Manager also completes the Wire Sheet.

If any portion is charged to an Operations/Cost Center, then the Account Manager must obtain 214 Region Manager's approval and signature on the Invoice Approval Form. Next, a Portfolio Analyst charges 216 the loan in a loan tracking system and enters payment or account break down on the invoice approval form. If the invoice will not be paid 218 at Closing, then the Portfolio Analyst sends 220 the completed Invoice Approval Form to paralegal for entry into the Tracking System. The invoice and approval form is then sent 222 to the company's processing and payment department for payment. Sending 222 the invoice and approval form to the processing department also serves as another control point.

Alternatively, if the invoice is to be paid 218 at Closing, then the law firms must agree to provide 224 the budget-to-variance comparison within 10 days after month end. If the law firm fails to provide 226 budget-to-variance comparison within 10 days after month end, the company should no longer pay the firm at closing. Instead the law firm will be paid only upon receipt of the budget-to-variance comparison. Next, the Account Manager or Portfolio Analyst obtains 228 approval signature from region underwriter, senior vice president, inside counsel or an on-line finance person. Then the company's Administrator of Finance, or comparable person, checks 230 that all required signatures are obtained on wire sheets to enable wire transfer.

After the required signatures are checked 230, the Administrator of Finance forwards 232 the original copy of invoice approval form back to the paralegal, who then updates 234 the tracking system. Also, the Administrator of Finance forwards 236 the wire sheet to the cash desk to send the wire transfer and the company's accounting department books manual-journal entry to record 238 the wire transfer.

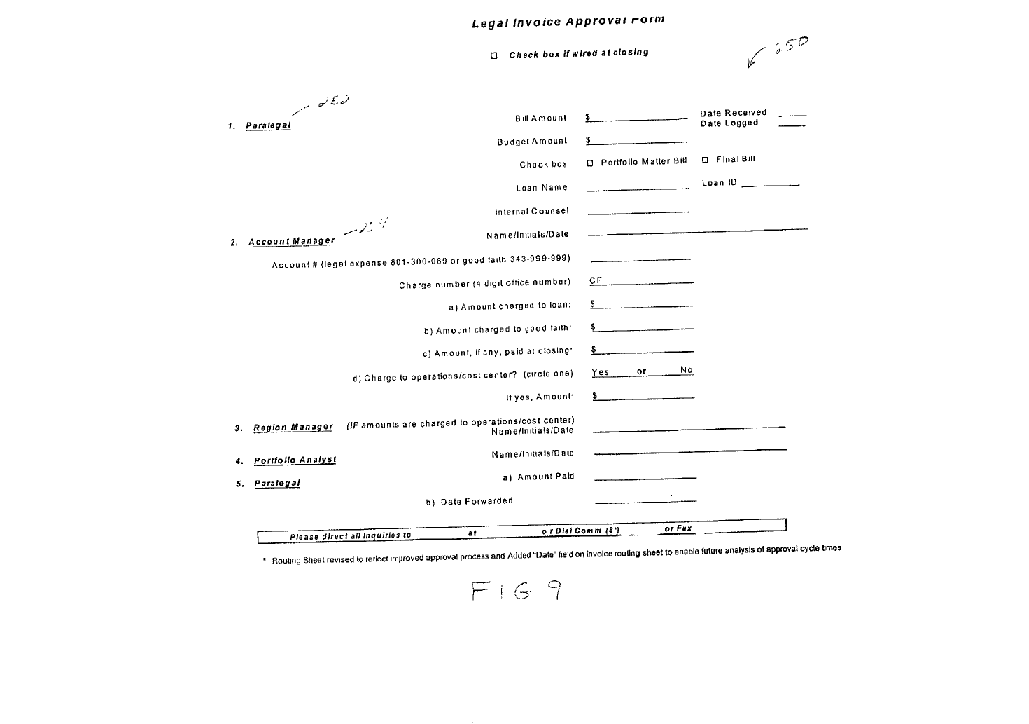

FIG. 9 is an exemplary example of an invoice and approval form 250 the paralegal sends 222 (shown in FIG. 8) to the processing department. A paralegal section 252 is completed, and a bill amount, a budget amount, date invoice received, and a date the invoice was logged is entered. Also, a choice is made whether this is a Portfolio Matter Bill or a Final Bill and checks the corresponding box. A Loan Name, Loan ID, and Internal Counsel's name are entered.

An account manager section 254 of the invoice and approval form 250 is completed by an Account Manager. The name, initials and date of the Account Manager are entered, along with an account number reflecting either a legal expense account to which the invoice will be charged or the account number for a good faith write-off is input. An office charge number is entered. Then an amount of the invoice charged to the loan, the amount charged to good faith and the amount, if any, paid at closing is displayed. A charge to the operations or cost center, if any is indicated and an amount is entered.

If any amount is charged to the operations/cost center, a name, initials and date of a Region Manager who gives approval to this allocation is entered. The Portfolio Analyst also enters his or her name, initials and date of approval. Finally, the paralegal inputs amount paid and a date the invoice is forwarded to the company's accounting department for payment.

There are several company best practices that emerges from the invoice approval process. First, a customer or borrower should never pay a law firm directly. The customer pays the company the amount of the law firm's legal services passed on to the customer. Second, the legal bills should be paid by wire at closing. The customers should expect an additional bill for out-of-pocket expenses, post-closing. Third, the cycle time between receipt of invoice by the paralegal and final payment by the company should be no more than 15 business days.

There are also best practices for the law firm. First, it should send invoices to a paralegal or administrative assistant, not to the account manager of inside counsel Second, the legal fees charged at closing should include actual fee amounts to most recent date plus an estimate of fees through the closing date.

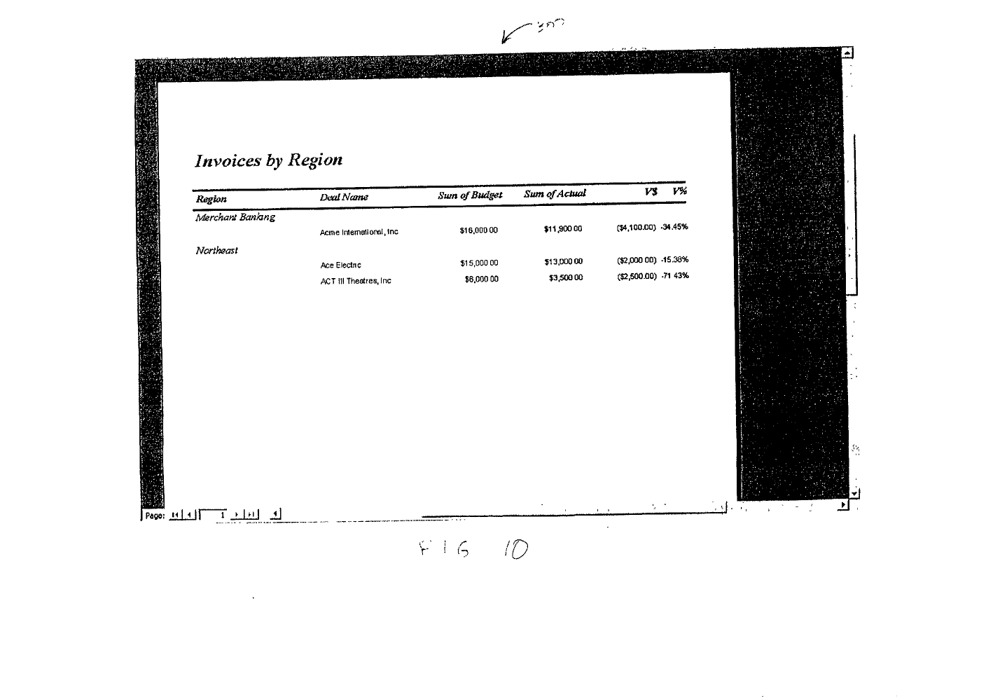

The Legal Expense Tracking System includes a database which allows users to generate and create various reports quickly. FIG. 10 is an example of an invoice report 300 by region. The information listed in invoice report 300 is by region name. Within each region, deal names are displayed. For each deal name, a sum of the budget for the legal work is shown as is a sum of the actual amounts billed by outside counsel. A difference between the amount actually billed and the amount budgeted is also shown. Finally difference is also expressed in percentage terms.

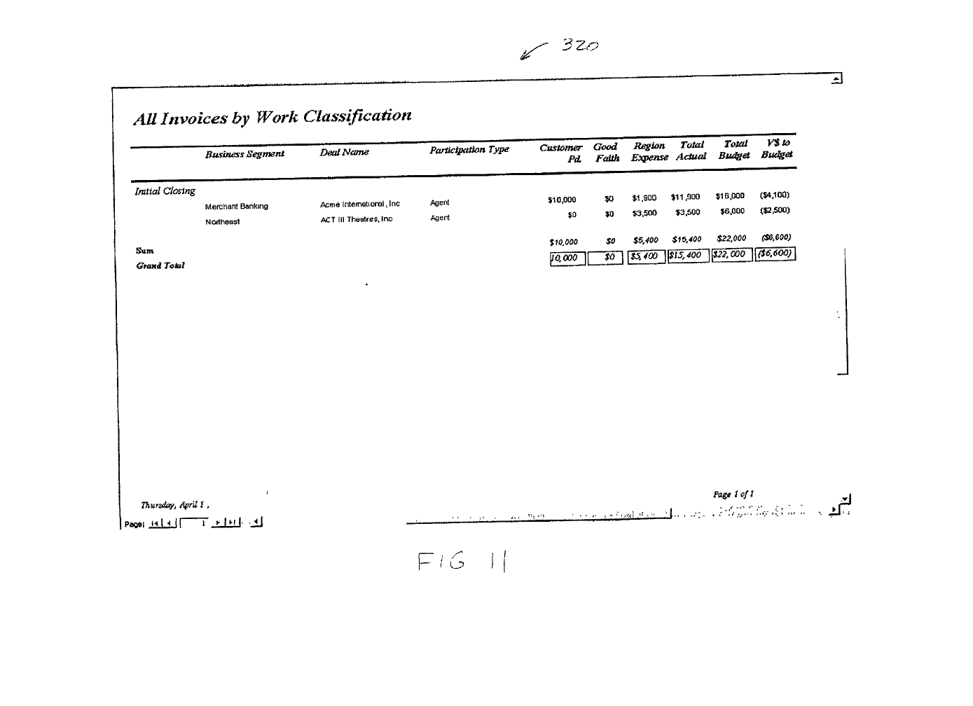

A non-exhaustive list of potential database reports follow. A report can be created showing the average budget for legal expenses for X borrower type in a particular region. Also, the budget data is examined in more detail by generating a report showing the average budget for a particular legal action item for a X borrower type. Alternatively, reports are created to compare the costs of different law firms by region or type of borrower. Additionally, and as shown in FIG. 11, a report by work classification 320 can be generated.

According to the method of the present invention, at least one legal invoice tracking and approval program is assessed and comparative reports are generated. The information provided in the reports facilitates decision-making concerning the selection and utilization of external legal resources. The reports show, for example, legal costs and variances from budgeted costs by law firm, region and borrower type. This information also is used to prepare better budgets on future projects. With this information, lenders manage expectations of legal expenses and enable analysis of spending, allowing the consumers of legal expenses to reduce legal expenses.

While the invention has been described in terms of various specific embodiments, those skilled in the art will recognize that the invention can be practiced with modification within the spirit and scope of the claims.

1. A method for operating a computer to facilitate tracking and approving of legal expenses using a legal expense tracking system, said method comprising the steps of:
prompting an inside counsel to generate a legal identifier for planned legal work;
prompting an outside counsel regarding the planned legal work;
prompting the outside counsel to input data relating to at least one expense;
prompting a user for an approval of the expense; and
generating at least one legal expense report.

2. A method according to claim 1 wherein said step of prompting outside counsel for a planned legal work further comprises the step of prompting outside counsel regarding any potential conflicts of interest.

3. A method according to claim 1 wherein said step of prompting outside counsel for a planned legal work further comprises the steps of:
prompting outside counsel with at least one header detail for a budget worksheet; and
prompting outside counsel to enter a prepared budget for the planned legal work in a budget worksheet format.

4. A method according to claim 3 wherein said step of prompting outside counsel with at least one header detail further comprises the step of prompting outside counsel at least one of a company data entry field, a closed date data entry field, a commitment data entry field, a borrower type data entry field, a legal contact data entry field, a work classification data entry field, a deal class data entry field, an account manager data entry field, an outside counsel data entry field, a principal office data entry field, a countries data entry field, a completion date data entry field, and an invoice ID data entry field.

5. A method according to claim 4 wherein said step of prompting outside counsel further comprises the step of prompting outside counsel with a check box for at least one of an interim comparison and a payment at closing.

6. A method according to claim 3 wherein said step prompting outside counsel to enter a prepared budget further comprises the step of sending the prepared budget to at least one of an account manager and an originator for review.

7. A method according to claim 3 wherein said step of uploading a prepared budget further comprises the step of prompting outside counsel to enter data relating to at least one of a structuring, a research, a first draft, a parcel of real estate, a due diligence, and a legal matter.

8. A method according to claim 7 wherein said step prompting outside counsel to enter data further comprises the step of prompting to enter data relating to at least one of an acquisition line, a capex line, a tax advice/planning, a credit agreement, a schedule, a security agreement, a certificate, a resolution, an opinion letter, a third party documentation, a mortgage, an escrow, a title search and a title policy.

9. A method according to claim 1 wherein said step of prompting the outside counsel to input data further comprising the step of prompting the outside counsel with a budget amount corresponding to a specific legal task having an associated code number.

10. A method according to claim 1 wherein said step of prompting the outside counsel to input data further comprises the step of prompting the outside counsel to enter into a budget worksheet an actual billed amount for at least one category delineated in the budget worksheet.

11. A method according to claim 1 wherein said step of prompting the outside counsel to input data further comprises the step of prompting the outside counsel to enter into a budget worksheet an iteration number for at least one categorized document.

12. A method according to claim 1 wherein said step of prompting a user for an approval of the expense further comprises the steps of:
prompting an account manager with an invoice; and
notifying a customer of an invoice amount.

13. A method according to claim 1 wherein said step of prompting a user for an approval of the expense further comprises the step of prompting a processing and payment department with an invoice and approval form.

14. A method according to claim 1 wherein said step of generating legal expense reports further comprises the step of generating an invoice report by at least one of region and legal work classification.

15. A method according to claim 14 wherein said step of generating an invoice report by region further comprises the step of generating a report which includes at least one of a deal name and a sum of a budget for the deal name.

16. A computer programmed to:
prompt an outside counsel regarding planned legal work, the legal work identified by a legal matter identifier;
prompt the outside counsel to input data relating to at least one expense;
prompt a user for an approval of the expense; and
generate at least one legal expense report.

17. A computer according to claim 16 wherein to prompt an outside counsel for a planned legal work, said computer displays a computer generated screen prompting outside counsel with at least one header detail for a budget worksheet and to enter a prepared budget for the planned legal work in a budget worksheet format.

18. A computer according to claim 17 wherein to prompt outside counsel with at least one header detail, said computer displays a computer generated screen comprising at least one of a company data entry field, a closed date data entry field, a commitment data entry field, a borrower type data entry field, a legal contact data entry field, a work classification data entry field, a deal class data entry field, an account manager data entry field, an outside counsel data entry field, a principal office data entry field, a countries data entry field, a completion date data entry field, and an invoice ID data entry field.

19. A computer according to claim 18, said computer configured to display a computer generated screen comprising a check box for at least one of an interim comparison and a payment at closing.

20. A computer according to claim 17 wherein to enter a prepared budget said computer displays computer generated screens relating to at least one of a structuring, a research, a first draft, a parcel of real estate, and a due diligence.

21. A computer according to claim 20 wherein said computer generated screens comprise at least one of an acquisition line, a capex line, a tax advice/planning, a credit agreement, a schedule, a security agreement, a certificate, a resolution, an opinion letter, a third party documentation, a mortgage, an escrow, a title search and a title policy.

22. A computer according to claim 16, wherein to prompt the outside counsel to input data, said computer displays a computer generated screen prompting the outside counsel with a budget amount corresponding to a specific legal task having an associated code number.

23. A computer according to claim 16, wherein to prompt the outside counsel to input data, said computer displays a computer generated screen prompting the outside counsel to enter into a budget worksheet an actual billed amount for at least one category delineated in the budget worksheet.

24. A computer according to claim 16 wherein to prompt the outside counsel to input data, said computer displays a computer generated screen prompting the outside counsel to enter into a budget worksheet an iteration number for at least one categorized document.

25. A computer according to claim 16 wherein to prompt a user for an approval of the expense, said computer programmed to:
prompt an account manager with an invoice; and
notify a customer of an invoice amount.

26. A computer according to claim 16 wherein to prompt a user for an approval of the expense, said computer programmed to prompt a processing and payment department with an invoice and approval form.

27. A computer according to claim 16 wherein to generate legal expense reports, said computer programmed to generate invoice reports by at least one of region and legal work classification.

28. A computer according to claim 16 wherein to generate an invoice report by region, said computer programmed to generate a report which includes at least one of a deal name and a sum of a budget for the deal name.

29. A database comprising:
data corresponding to a legal matter identifier;
data corresponding to contacting of outside counsel;
data corresponding to legal expenses; and
data corresponding to approval of the legal expenses.

30. A database according to claim 29 comprising data corresponding to header detail and prepared budget for legal work.

31. A database according to claim 29 comprising data corresponding to code numbers for specific legal tasks.

32. A database according to claim 29 comprising data corresponding to an iteration number for a document.

33. A database according to claim 29 comprising data corresponding to an invoice report by at least one of region and legal work classification.

34. A system for legal expenses tracking/approval comprising:
a computer configured as a server, and further configured to generate legal expense reports said server comprising a legal expense database which comprises data corresponding to legal matter identifiers, data corresponding to contacting of outside counsel, data corresponding to legal expenses and data corresponding to approval of the legal expenses;
at least one other computer coupled to said server forming a network, each said other computer includes an interface allowing said other computer and said server to communicate therebetween, said interface configured to allow said other computer to upload data relating to legal invoices to said server and to allow said server to download legal expense data comprising at least one legal expense report to said other computer.

35. A system according to claim 34 wherein said server further configured to upload conflict of interest data to said legal expense database.

36. A system according to claim 34 wherein said database further comprises data corresponding to header detail and prepared budget for legal work.

37. A system according to claim 34 wherein said database comprises data corresponding to code numbers for specific legal tasks.

38. A system according to claim 34 wherein said database comprises data corresponding to an iteration number for a document.

39. A system according to claim 34 wherein said database comprises data corresponding to an invoice report by at least one of region and legal work classification.

40. A system according to claim 34 wherein said server is configured to:
cause a screen listing at least one header detail for a budget worksheet; and
cause to be stored in said database a prepared budget for planned legal work in a budget worksheet format.

41. A system according to claim 40 wherein the header detail comprises at least one of a company data entry field, a closed date data entry field, a commitment data entry field, a borrower type data entry field, a legal contact data entry field, a work classification data entry field, a deal class data entry field, an account manager data entry field, an outside counsel data entry field, a principal office data entry field, a countries data entry field, a completion date data entry field, and an invoice ID data entry field.

42. A system according to claim 34 wherein said server is further configured to cause a screen listing data relating to at least one of a structuring, a research, a first draft, a parcel of real estate, and a due diligence.

43. A system according to claim 42 wherein data relating to at least one of a structuring, a research, a first draft, a parcel of real estate, and a due diligence comprises data relating to at least one of an acquisition line, a capex line, a tax advice/planning, a credit agreement, a schedule, a security agreement, a certificate, a resolution, an opinion letter, a third party documentation, a mortgage, an escrow, a title search and a title policy.

44. A system according to claim 34 wherein said server further configured to cause a screen listing at least one budget amount corresponding to a specific legal task having an associated code number.

45. A system according to claim 34 wherein said server is further configured to cause a screen listing an actual billed amount for at least one category delineated in said legal expense database and an iteration number relating to a categorized document.

46. A system according to claim 34 wherein said server is further configured to cause a screen listing an invoice and approval form.

47. A system according to claim 46 wherein said server is further configured to cause a screen listing an invoice report by region.

48. A method for tracking and approving legal expenses, said method comprising the steps of:
selecting, from an electronic interface, to notify at least one outside counsel regarding legal work and to prompt the outside counsel to input data relating to at least one legal expense;
selecting, from the electronic interface, to approve the input expense; and
requesting, from the electronic interface, a legal expense report comprising the legal expense input data.

49. A method according to claim 48 further comprising the step of selecting, from the electronic interface, a legal matter identifier for the legal work.

50. A method according to claim 48 wherein selecting to notify outside counsel comprises the step of prompting outside counsel regarding any potential conflicts of interest.

51. A method according to claim 48 selecting to notify outside counsel comprises the steps of:
selecting, from the electronic interface, to prompt outside counsel with at least one header detail for a budget worksheet; and
selecting, from the electronic interface, to prompt outside counsel to enter a prepared budget for planned legal work in a budget worksheet format.

52. A method according to claim 48 further comprising the step of selecting, from the electronic interface, to send a prepared budget to at least one of an account manager and an originator for review.

53. A method according to claim 48 further comprising the steps of:
selecting, from the electronic interface, to send an invoice to an account manager; and
selecting, from the electronic interface, to notify a customer of an invoice amount.

54. A method according to claim 48 further comprising the step of selecting, from the electronic interface, to forward an invoice and approval form.

55. A method according to claim 48 further comprising the step of requesting, from the electronic interface, an invoice report by at least one of region and legal work classification.

56. Apparatus comprising:
means for prompting an outside counsel regarding planned legal work;
means for prompting the outside counsel to input data relating to at least one expense;
means for prompting a user for an approval of the expense; and
means for generating at least one legal expense report.

57. Apparatus according to claim 56 wherein said means for prompting an outside counsel comprises:
means for generating a computer generated screen for prompting the outside counsel with at least one header detail for a budget worksheet; and
means for generating a computer generated screen for prompting the outside counsel to enter a prepared budget for the planned legal work in a budget worksheet format.

58. Apparatus according to claim 56 wherein said means for prompting the outside counsel to input data comprises means for generating a computer screen for prompting the outside counsel with a budget amount corresponding to a specific legal task, the task having an associated code number.

59. Apparatus according to claim 56 wherein said means for prompting a user for an approval comprises:
means for prompting an account manager with an invoice; and
means for notifying a customer of an invoice amount.

60. Apparatus according to claim 56 wherein said means for prompting a user for an approval comprises means for prompting a processing department with an invoice and approval form.

61. Apparatus according to claim 56 wherein said means for generating at least one legal expense report comprises means for generating invoice reports by at least one of by region, by deal name and by legal work classification.

62. A computer-readable medium comprising:
records corresponding to at least one legal matter identifier;
records corresponding to at least one outside counsel;
at least one record of submitted legal expenses; and
a plurality of rules for approval of submitted legal expenses.

63. A computer-readable medium according to claim 62 further comprising:
at least one record of header detail; and
at least one record of a prepared budget for legal work.

64. A computer-readable medium according to claim 62 further comprising a record of code numbers corresponding to specific legal tasks.

65. A computer-readable medium according to claim 62 further comprising a record of iteration numbers corresponding to documents.

66. A computer-readable medium according to claim 62 further comprising:
at least one record corresponding to a regional invoice report; and
at least one record corresponding to a legal work classification.
